(19) United States
(12) Patent Application Publication
(10) Pub. No.: US 2014/0199438 A1
(43) Pub. Date: Jul. 17, 2014

(54) METHOD OF SUPPLYING OXYGENATED WATER

(71) Applicant: BIYOUNG BIOTECHNOLOGY CO., LTD., Tortola (GB)

(72) Inventors: SHU-FEN LEE, Taipei (TW); CHE-WEI LIN, Kaohsiung (TW); SHIH-MING TUNG, Kaohsiung (TW)

(73) Assignee: BIYOUNG BIOTECHNOLOGY CO., LTD., Tortola (GB)

(21) Appl. No.: 13/796,752

(22) Filed: Mar. 12, 2013

(30) Foreign Application Priority Data
Jan. 15, 2013 (TW) 102101507

(51) Int. Cl. A23L 2/54

(52) U.S. Cl. CPC A23L 2/54
USPC 426/67

(57) ABSTRACT

A method of supplying oxygenated water is performed on a water tank, in which oxygenated water is received. The method lets the water tank supply a constant amount of the oxygenated water once, and then supply the water tank with water and pure oxygen to recover the dissolution ratio of oxygen of the oxygenated water in the water tank. The method may supply a constant amount of oxygenated water every time for the user to drink it up once.

### BACKGROUND OF THE INVENTION

1. Technical Field

The present invention relates to drinking water, and more particularly to a method of supplying oxygenated water.

2. Description of Related Art

Oxygenated water is made by dissolving pure oxygen in water. The oxygenated water with 60 ppm oxygen has fine white bubbles within, and the oxygenated water with 100 ppm or more oxygen turns its color to milk white. People drink oxygenated water for absorbing the oxygen in the water to activate body cells. However, the oxygen tends to escape from the water easily, therefore people has to drink it up before it turning back into transparent.

It is convenient for consumers to buy bottled oxygenated water in a store. However, oxygen will escape from the water every time when the bottle is opened. It causes the dissolution ratio of oxygen in the remained water reduces if one doesn't drink the whole bottle once. Therefore, how to keep a constant dissolution ratio of oxygen in the oxygenated water every time when one wants to drink is an important issue.

### BRIEF SUMMARY OF THE INVENTION

In view of the above, the primary objective of the present invention is to provide a method of supplying oxygenated water, which keeps a constant dissolution ratio of oxygen in the oxygenated water every time when one wants to drink.

The secondary objective of the present invention is to provide a method of supplying oxygenated water, which controls the flowing speed of water by providing high air pressure to stabilize the oxygenated water supply.

The present invention provides a method of supplying oxygenated water, wherein the method is performed on a water tank, in which oxygenated water is received; the water tank has a water inlet, a water outlet, a gas inlet, and a gas outlet; and the gas outlet is on a top of the water tank, and the gas inlet is on a bottom of the water tank; the method comprising the steps of:

a). Keep a pressure in a space above a water level of the oxygenated water in the water tank at a first pressure;

b). Open the water outlet to let a constant amount of the oxygenated water flow out of the water tank, and then close the water outlet; and

c). Supply the water tank with water to keep the pressure in the space above the water level of the oxygenated water in the water tank at a second pressure, wherein the second pressure is greater than or equal to the first pressure.

The method of the present invention supplies a constant amount of oxygenated water every time for the user to drink it up once.

### BRIEF DESCRIPTION OF THE SEVERAL VIEWS OF THE DRAWINGS

The present invention will be best understood by referring to the following detailed description of some illustrative embodiments in conjunction with the accompanying drawings, in which:

FIG. 1 is a sketch diagram of the oxygenated water system of a preferred embodiment of the present invention;

FIG. 2 is a flowchart of supplying oxygenated water of the preferred embodiment of the present invention; and

FIG. 3 is a sketch diagram of the water tank of the preferred embodiment of the present invention.

### DETAILED DESCRIPTION OF THE INVENTION

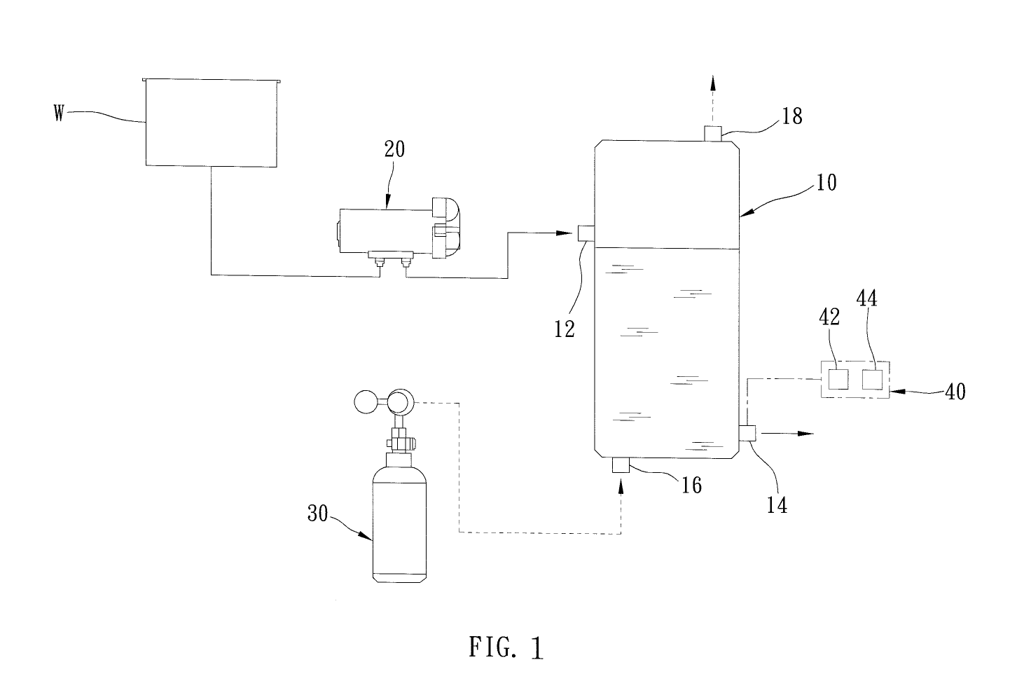

FIG. 1 shows a system of making oxygenated water of the preferred embodiment of the present invention, which includes a water tank 10, a pump 20, an oxygen supplier, which is an oxygen cylinder 30 in the present embodiment, and a controller 40.

The water tank 10 has a water inlet 12, a water outlet 14, a gas inlet 16, and a gas outlet 18. The water inlet 12 is on a sidewall of the water tank 10, and is adjacent to a top thereof. The water outlet 14 is on the sidewall of the water tank 10, and is adjacent to a bottom thereof. The high oxygenated water comes out of the water tank 10 through the water outlet 14. The gas inlet 16 is on the bottom of the water tank 10. An oxygen supplier is connected to the gas inlet 16. In the present embodiment, the oxygen supplier is an oxygen cylinder 30. Pure oxygen of the oxygen cylinder 30 enters the water tank 10 through the gas inlet 16 and is dissolved in the water. It may obtain oxygenated water with higher concentration of dissolved oxygen while the pure oxygen from the oxygen cylinder 30 has longer time to contact with water. The gas outlet 18 is on the top of the water tank 10 for the useless gas in the water tank 10 to escape.

A water source W is connected to the water inlet 12 of the water tank 10 to supply the water tank 10 with water through the pump 20. The water of the water source W is drinkable, such as RO water. It is preferable that the water of the water source W is low oxygenated water. The pump 20 is turned on or off according to a pressure in the water tank 10.

The controller 40 is able to open or close the water inlet 12 and the water outlet 14. The controller 40 has a circuit 42 and a panel 44. The panel 44 is electrically connected to the circuit 42 and has several buttons (not shown). People would operate the buttons of the panel to open or close the water inlet 12 and the water outlet 14.

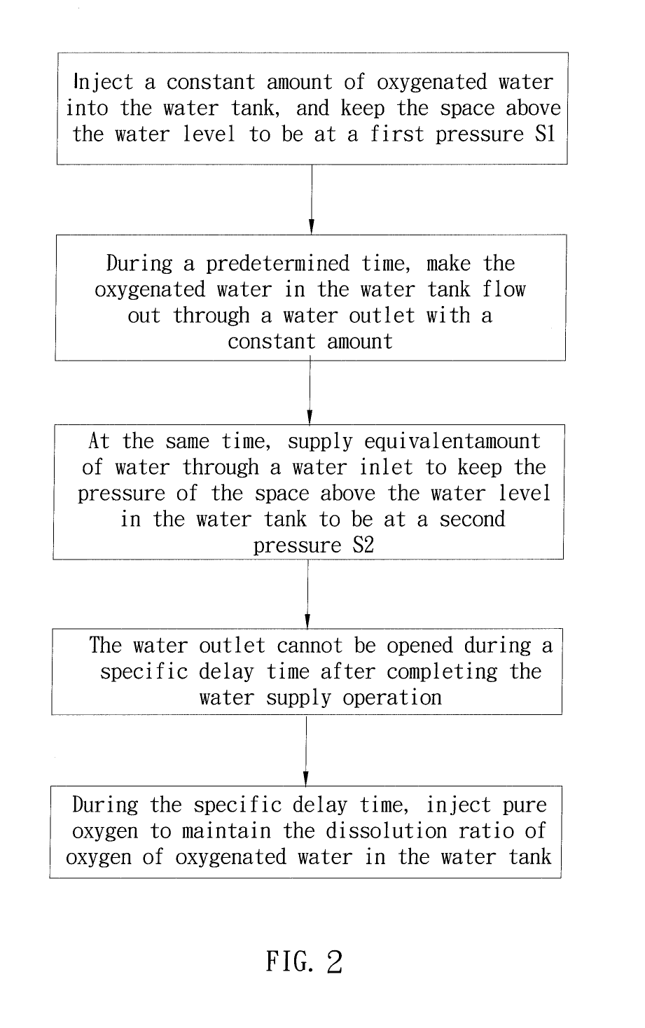

As shown in FIG. 2, a method of supplying oxygenated water of the preferred embodiment of the present invention is performed on the system above, and the water tank 10 has oxygenated water therein. The method includes the following steps:

Close the water outlet 14, the gas inlet 16, and the gas outlet 18 of the water tank 10, and start the pump 20 to supply the water tank 10 with water through the water inlet 12. It will make a water level of the water in the water tank 10 rise, and a pressure in a space above the water level increase. When a first pressure S1 is sensed in the space above the water level, the pump 20 is turned off to stop the water supplying to the water tank 10. The first pressure S1 varies according to the size of the water tank 10, and usually is in a range between 5 atms and 20 atms.

The circuit 42 of the controller 40 is set by the designer to control the time of opening and closing the water outlet 14, so that the water tank 10 provides a constant amount of oxygenated water once. In an embodiment, the water outlet 14 is opened for 0.3 seconds when the pressure in the space above the water level is at the first pressure S1. 100 cc oxygenated water will be supplied in 0.3 seconds. In other words, when a user presses a supply button of the panel 44 once, the water tank 10 will supply 100 cc oxygenated water for the user to drink it up once. In an embodiment, there are buttons on the panel 44 to increase or decrease the amount of supplying oxygenated water once.

When the oxygenated water flows out through the water outlet 14, the water level lowers and the pressure in the space above the water level reduces. In an embodiment, the pump 20 is turned on to supply the water tank 10 with water once the water outlet 14 is opened, and the pump 20 is turned off when the pressure of the space above the water level is sensed to exceed a second pressure S2. The second pressure S2 is greater than or equal to the first pressure S1. It may keep a constant pressure in the water tank 10 to supply a constant amount of oxygenated water every time the user presses the supply button. In an embodiment, the pump 20 is turned on when the water outlet 14 is closed.

The method of the present invention supplies a constant amount of oxygenated water every time the user presses the supply button for the user to drink it up once.

It is easy to understand that the dissolution ratio of oxygen of the water in the water tank 10 reduces after the water outlet 14 being opened for the oxygenated water to flow out. In an embodiment, the method of the present invention further includes the step of holding the water outlet 14 closed for a holding time after the water outlet 14 is closed. After the predetermined amount of oxygenated water is supplied, the gas inlet 16 is opened to supply the water tank 10 with pure oxygen, and the pure oxygen may be dissolved in the water in the holding time. Therefore, there will be a constant dissolution ratio of oxygen in the oxygenated water which comes out from the water tank 10.

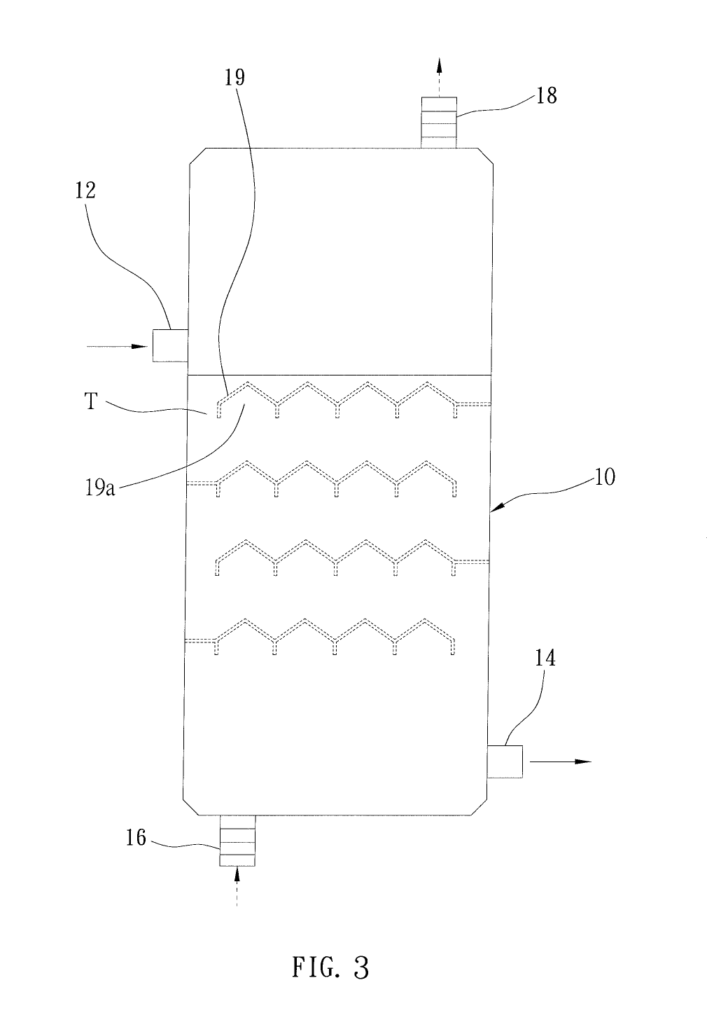

In order to make more pure oxygen to be dissolved in the water, the water tank 10 is provided with a postponing device to extend the time for the oxygen staying in the water tank 10. As shown in FIG. 3, the postponing device has a plurality of plates 19 transversely mounted in the water tank 10. The plates 19 respectively have an opening T, and the openings T are alternately on the left and right of the plates 19, so that a continuous S-shaped passageway is formed in the water tank 10. Each plate 19 is wave-shaped, so that each plate 19 has a plurality of exchanging rooms 19a thereunder. Oxygen may stay in the exchanging rooms 19a to be dissolved in the water when the Oxygen goes through the continuous S-shaped passageway. It is noted that any similar design in the water tank 10 to extend the time of the oxygen staying in the water tank 10 should be still in the scope of the present invention.

It must be pointed out that the embodiments described above are only some preferred embodiments of the present invention. All equivalent structures and manufacturing methods which employ the concepts disclosed in this specification and the appended claims should fall within the scope of the present invention.

What is claimed is:

1. A method of supplying oxygenated water, wherein the method is performed on a water tank, in which oxygenated water is received; the water tank has a water inlet, a water outlet, a gas inlet, and a gas outlet; and the gas outlet is on a top of the water tank, and the gas inlet is on a bottom of the water tank, the method comprising the steps of:
a). keeping a pressure in a space above a water level of the oxygenated water in the water tank at a first pressure;
b). opening the water outlet to let a constant amount of the oxygenated water flow out of the water tank, and then closing the water outlet; and
c). supplying the water tank with water to keep the pressure in a space above a water level of the oxygenated water in the water tank at a second pressure, wherein the second pressure is greater than or equal to the first pressure.

2. The method of claim 1, wherein an amount of the water supplied to the water tank in the step c) is equal to the amount of the oxygenated water flowing out of the water tank in the step b).

3. The method of claim 1, wherein the pump is turned on to pump the water from a water source to the water tank in the step c).

4. The method of claim 3, wherein the pump is turned on when the water outlet is closed in the step c).

5. The method of claim 3, wherein the pump is turned on when the water outlet is opened in the step c).

6. A method of claim 3, wherein the water of the water source is oxygenated water.

7. The method of claim 1, further comprising the step of holding the water outlet closed for a holding time after the step c).

8. The method of claim 7, further comprising the step of supplying the water tank with pure oxygen through the gas inlet in the holding time.

9. The method of claim 1, further comprising the step of extending a time of pure oxygen staying in the water tank.

10. The method of claim 9, wherein the water tank is provided with a postponing device, which has a plurality of plates in the water tank, and each of the plates has at least an exchanging room thereunder to receive the pure oxygen therein.
